(19) United States
(12) Patent Application Publication
(10) Pub. No.: US 2016/0027027 A1
(43) Pub. Date: Jan. 28, 2016

(54) SYSTEM AND METHOD OF MARKET VALUATION FOR RESOURCE EXTRACTION COMPANIES USING MONTE CARLO SIMULATION

(71) Applicant: Justin D. ANDERSON, Calgary (CA)

(72) Inventor: Justin D. Anderson, Calgary (CA)

(21) Appl. No.: 14/782,264

(22) PCT Filed: Apr. 2, 2013
(86) PCT No.: PCT/CA2013/050266

§ 371 Date: Oct. 2, 2015

(51) Int. Cl. G06Q 30/02; G06F 17/50; G06N 7/00

(52) U.S. Cl. CPC G06Q 30/0202; G06N 7/005; G06F 17/5009

(57) ABSTRACT

In general, in one aspect, the invention relates to a method for determining an exploration portfolio value. The method includes receiving a request for the exploration portfolio value targeting an exploration portfolio, where the request comprises exploration site data, obtaining a fiscal regime estimation for the exploration site data, and obtaining a capital expenditure estimation for the exploration site data. The method further includes adjusting the exploration site data using the fiscal regime estimation and the capital expenditure estimation to obtain adjusted exploration site data, generating a probability distribution by executing, using a computer processor, a Monte Carlo simulation on the adjusted exploration site data, and determining the exploration portfolio value from the probability distribution.

### BACKGROUND

Resource extraction sites are frequently collected into portfolios of resource sites that are either currently undergoing resource extraction or are in one of the various stages of preparation for extraction. Consequently, the organizations holding such portfolios have a value which is heavily dependent upon the accepted value of those portfolios. However, estimates of resource sites generally fail to appropriately account for the numerous factors affecting the value of each site during actual extraction affecting the value of the organization holding such portfolios.

### SUMMARY

In general, in one aspect, the invention relates to a method for determining an exploration portfolio value. The method includes receiving a request for the exploration portfolio value targeting an exploration portfolio, where the request comprises exploration site data, obtaining a fiscal regime estimation for the exploration site data, and obtaining a capital expenditure estimation for the exploration site data. The method further includes adjusting the exploration site data using the fiscal regime estimation and the capital expenditure estimation to obtain adjusted exploration site data, generating a probability distribution by executing, using a computer processor, a Monte Carlo simulation on the adjusted exploration site data, and determining the exploration portfolio value from the probability distribution.

In general, in one aspect, the invention relates to a system including a computer processor, a fiscal regime abstraction module, a capital expense abstraction module, a Monte Carlo simulation module, and a downside risk adjustment module. The fiscal regime abstraction module is configured to generate a fiscal regime estimation for exploration site data. The capital expense abstraction module is configured to generate a capital expense estimation for the exploration site data. The Monte Carlo simulation module is configured to receive a request for the exploration portfolio value targeting an exploration portfolio, where the request comprises the exploration site data, obtain a fiscal regime estimation from the fiscal regime abstraction module, and obtain a capital expenditure estimation from the capital expense abstraction module. The Monte Carlo simulation module is further configured to adjust the exploration site data using the fiscal regime estimation and the capital expenditure estimation to obtain adjusted exploration site data and generate a probability distribution by a Monte Carlo simulation on the adjusted exploration site data. The downside risk adjustment module is configured to determine the exploration portfolio value from the probability distribution.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flow diagram in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for generating an exploration portfolio value. Specifically, embodiments of the invention may be used to analyze an exploration portfolio using a probabilistic methodology.

Resource extraction companies maintain a portfolio of leased resource sites from which the company extracts the resources. At any given point in time, each resource site is associated with a point in the resource site lifecycle. Prospective sites refer to resource sites that are under the control of the resource extraction company, but often insufficient information exists regarding whether or the amount of resources that may be extracted from the site has been gathered. Exploration sites refer to resource sites that have yet to produce the extractable resource, but have been examined to a sufficient degree regarding the ability of the site to produce resources, and extraction of the resources is expected to begin in the near future. Finally, producing sites refer to resource sites that are currently undergoing resource extraction.

Generating a reliable estimate of the value of a collection of exploration sites requires accurate consideration of the numerous variables involved. Embodiments of the present invention use a four-step process to generate an accurate exploration portfolio valuation: first, exploration data from the exploration portfolio is adjusted based on discovery scenarios; second, the exploration data is adjusted based on the fiscal regime of the exploration site; third, a Monte Carlo simulation is executed using the adjust exploration data to generate a probability distribution; and finally, a single valuation is extracted from the resulting probability distribution.

Embodiments of the invention may be applicable to portfolios of leases on various kinds of resource extraction sites. In one embodiment of the invention, resource extraction sites may include, for example, hydrocarbon wells (including oil wells and natural gas deposits), precious metal mines, and underground aquifers (e.g., water wells). Further, leases included in a portfolio may include reservoir extraction leases. Reservoir extraction leases may include various types of leases, such as oil well leases, water well leases, gas well leases, and mine leases.

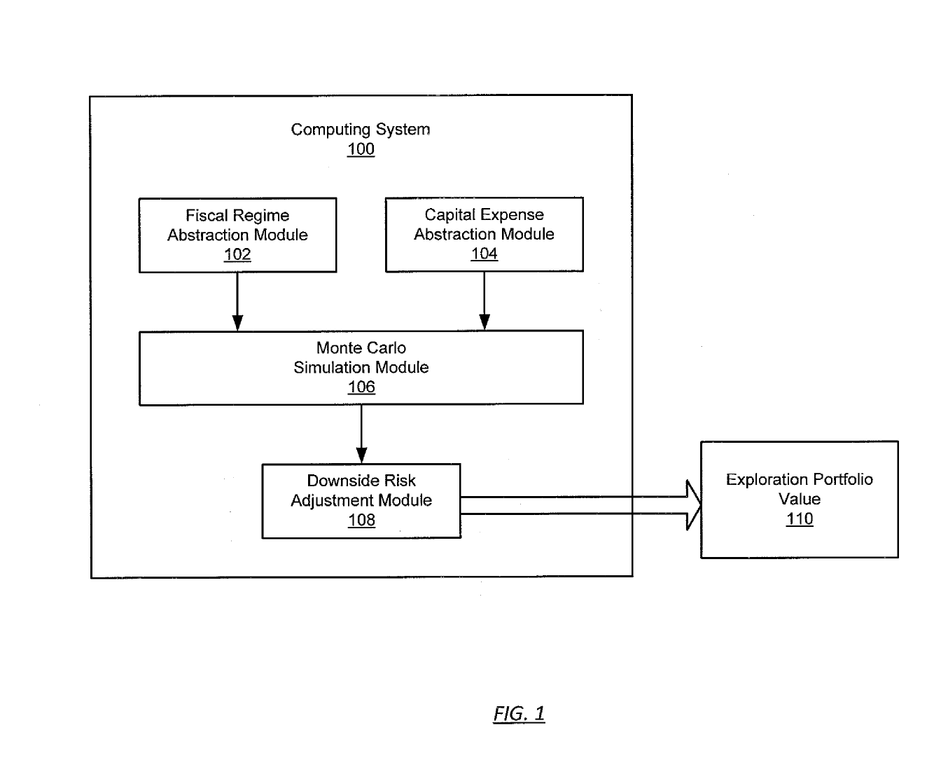

FIG. 1 shows a diagram of a system in accordance with one or more embodiments of the invention. As shown in FIG. 1, the computing system (100) includes a fiscal regime abstraction module (102), a capital expense (capex) abstraction module (104), a Monte Carlo simulation module (106), and an downside risk adjustment module (108).

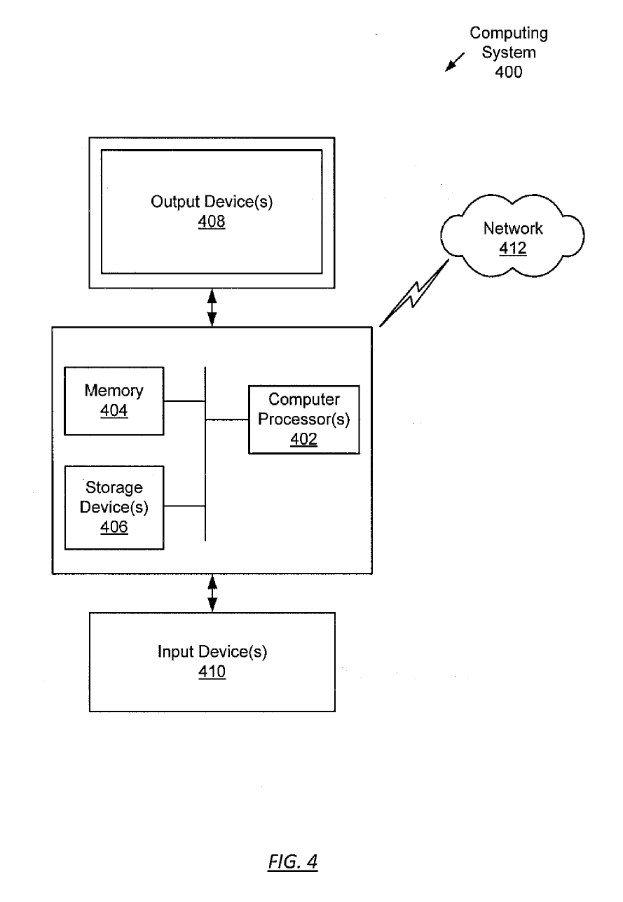

In one or more embodiments of the invention, the computing system (100) is a combination of hardware and software configured to execute the fiscal regime abstraction module (102), capex abstraction module (104), Monte Carlo simulation module (106), and downside risk adjustment module (108). In one or more embodiments of the invention, the computing system (100) includes various hardware and software components of a specialized computing systems, such as the computing system shown and described in relation to FIG. 4.

In one or more embodiments of the invention, the Monte Carlo simulation module (106) is a process or group of processes with functionality to generate a probability distribution. Specifically, the Monte Carlo simulation module (106) receives exploration site data and uses the data to produce a probability distribution expressing the net asset value (NAV) of the exploration sites in terms of their distribution along an x-axis of values. In one or more embodiments of the invention, the Monte Carlo simulation module (106) is executed using two key exploration distributions: the chance of geological success (Pg) and the field size distribution (the P90-P50-P10 of the prospect). In one or more embodiments of the invention, a meaningful distribution of output NAVs requires a high number of iterations (e.g., 5,000-10,000 iterations). In one or more embodiments of the invention, the data used by the Monte Carlo simulation module (106) is adjusted using the fiscal regime abstraction module (102) and the capex abstraction module (104).

In one or more embodiments of the invention, the capex abstraction module (104) adjusts the input data for the Monte Carlo simulation module (106) to account for the applicable capital expenditures required to extract the resources from the exploration site. In one or more embodiments of the invention, the capex abstraction module (104) accounts for a wide range of discovery scenarios. In one or more embodiments of the invention, the capex abstraction module (104) uses a regression model to back out a relationship between field size discovered, depth of field discovered, and capital required per proven or probable unit (e.g., barrel). In one or more embodiments of the invention, the capex abstraction module (104) determines the relationship between the above variables from an intensive research process of accumulating data-points for a field's development cost, depth, and reserves.

In one or more embodiments of the invention, the fiscal regime abstraction module (102) adjusts the input data for the Monte Carlo simulation module (106) to account for the applicable fiscal regimes surrounding the exploration sites. In one or more embodiments of the invention, a fiscal regime is the group of financial factors that affect the cost of extracting resources from a exploration site based on the location of the exploration site. For example, the first 5 million barrels of oil produced in a Colombian oil field are exempt from high price royalties, and therefore an exploration site subject to this fiscal regime that was to produce 5 million barrels would have a very different royalty structure than an exploration site governed by the same regime that produced 15 million barrels. In one or more embodiments of the invention, the fiscal regime abstraction module (102) defines the fiscal regime in generalized terms, and searches an underlying database of fiscal terms to incorporate the generalized fiscal regime structure specific for that particular discovery and contract into each iteration of the Monte Carlo simulation module (106).

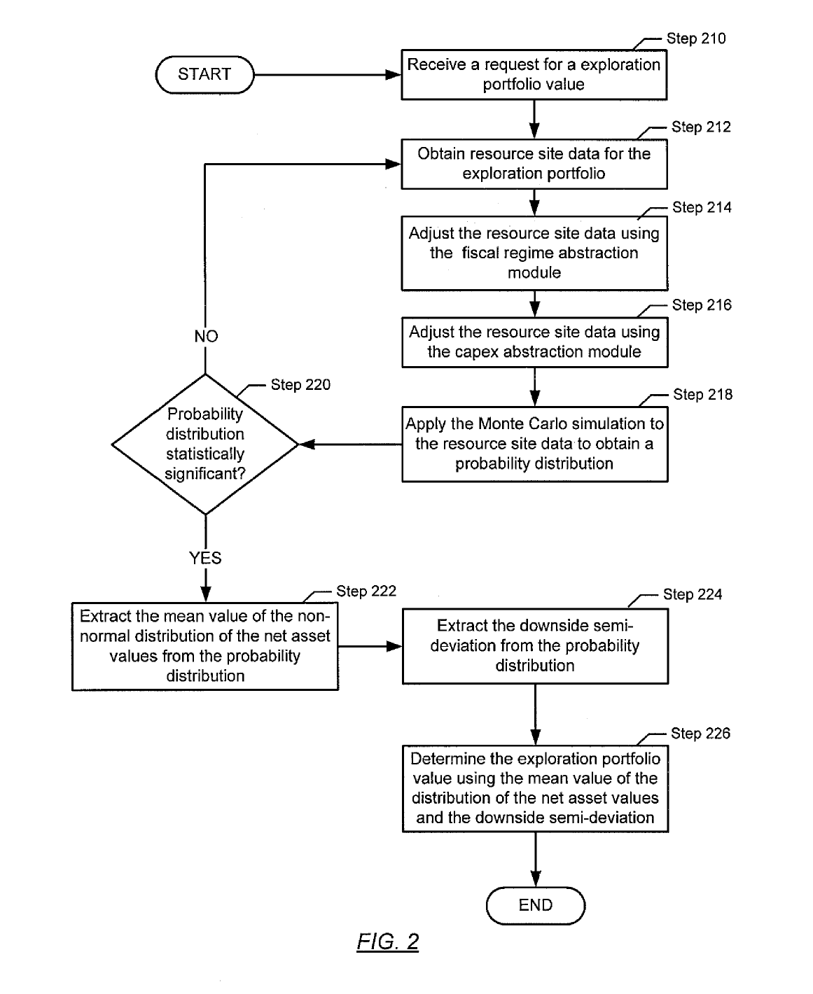

In one or more embodiments of the invention, the downside risk adjustment module (108) generates a single value or small number of values (e.g., the exploration portfolio value (110)) from the probability distribution produced by the Monte Carlo simulation module (106). In one or more embodiments of the invention, the downside risk adjustment module (108) determines the value of a distribution of net present values (NPVs) based on the average market-participant's level of risk aversion. Further detail regarding the downside risk adjustment module (108) is provided in FIG. 2.

FIG. 2 shows a flowchart for generating an exploration portfolio valuation in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel.

In Step 210, the computing system receives a request for an exploration portfolio value. In Step 212, the computing system obtains exploration site data for the exploration portfolio. In one or more embodiments of the invention, the exploration site data includes data about the location of each resource site, the chance of geological success, and the field size distribution. In Step 214, the exploration site data is adjusted using the fiscal regime abstraction module. In one or more embodiments of the invention, the costs associated with the business aspect of extracting resources from each exploration site is estimated according to the applicable financial factors associated with extraction at a particular location.

In Step 216, the exploration site data is adjusted using the capex abstraction module. In one or more embodiments of the invention, the exploration site data is modified to account for the costs associated with extracting resources from each exploration site. In one or more embodiments of the invention, the capex abstraction module estimates the extraction costs for resource extraction from each exploration site, and adjusts the resource data according to that estimate.

In Step 218, the Monte Carlo simulation is applied to the adjusted exploration site data and a data point is generated and added to the probability distribution. In Step 220, the computing system determines whether enough data points exist in the probability distribution to be statistically significant. If in Step 220, the computing system determines that there is statistically insufficient data points in the probability distribution, then the computing system returns to Step 212 and re-executes the simulation (i.e., executes another iteration).

If in Step 220, the computing system determines whether statistically sufficient data points exist in the probability distribution, then in Step 222, the mean value of the distribution of the NAVs is extracted from the probability distribution. In Step 224, the downside semi-deviation is extracted from the probability distribution. In Step 226, the exploration portfolio value is determined using the mean value of the distribution of the NAVs and the downside semi-deviation. Specifically, in one or more embodiments of the invention, the exploration portfolio value may be determined in terms of an appropriate initial investment (ii) in the company holding the exploration portfolio.

In order to calculate the initial investment (ii), the following formula may be applied:

$$R = \frac{( Ep - ii )}{ii}$$

where R is the return on the initial investment and Ep is the mean value of the distribution of NPVs. The following formula may be applied to determine the return on investment for the downside semi-deviation case (Rd):

$$Rd = \frac{( Ep - ii ) - dd}{ii}$$

where dd is the mean value minus the downside deviation. The downside semi-deviation (SD) may be calculated from the return on the initial investment (R) and the return on investment for the downside semi-deviation case (Rd) using the following formula:

SD=R−Rd

Finally, the return on the initial investment (R) may also be calculated using the return required for cash flows not subject to exploration-specific risk (Rf) (i.e., exploration risk-free rate) and the additional return required to compensate for exploration-specific risk (Re):

R=Rf+Re

In one embodiment of the invention, the return required for cash flows not subject to exploration-specific risk (Rf) is different than the commonly known “risk free rate.” The return required for cash flows not subject to exploration-specific risk (Rf) is the discount rate that would be applied to the assets absent of exploration risk, but still subject to political, economic, and other risks that would increase the return required for cash flows not subject to exploration-specific risk (Rf) beyond a treasuries-type risk free asset. The additional return required to compensate for exploration-specific risk (Re) may be calculated using the downside semi-deviation (SD) and the Sharp ratio (SR) using the following formula:

Re=SR×SD

Using the above formulas, the initial investment (ii) may be calculated using:

$$ii = \frac{Ep - SR \times dd}{Rf + 1}$$

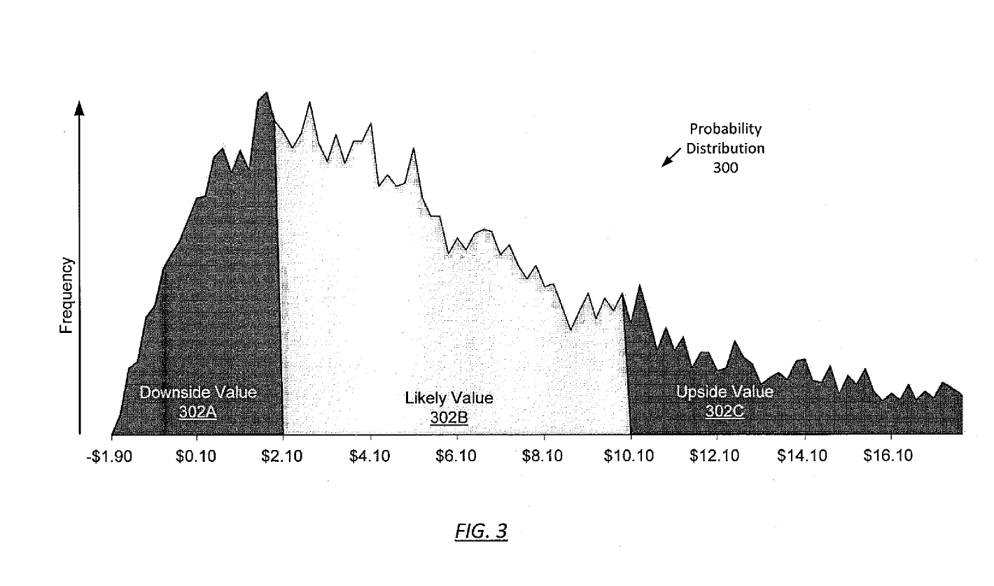

FIG. 3 shows an example probability distribution in accordance with one or more embodiments of the invention. For the purposes of the example, assume the following: the exploration portfolio being evaluated includes 1000 exploration sites subject to 100 different fiscal regimes; each exploration site has is associated with location data and data regarding the amount of resources potentially extractable from the exploration site, dependent upon various environmental and geological factors; each fiscal regime is dependent upon the amount extracted from the exploration site; each data point is calculated as a price-per-stock of the company holding the exploration portfolio; a statistically significant set of data points is at least 10,000 data points. Also assume the following: the Sharp ratio (SR) is 35%; the return required for cash flows not subject to exploration-specific risk (Rf) is 110% and the additional return required to compensate for exploration-specific risk (Re) is 40%.

Continuing with the example of FIG. 3, the exploration site data is obtained and adjusted according to a first set of fiscal regime estimates and capex estimates. The Monte Carlo simulation is executed using the adjusted exploration site data, and a data point of $2.10 results. The process is repeated 9,999 more times, each time using generated fiscal regime estimates and capex estimates. The resulting data points are shown in the probability distribution (300).

As shown in FIG. 3, the probability distribution (300) includes a downside value (302A), a likely value (302B), and an upside value (302C). The downside value (302A) represents the data points corresponding to the 0 to 25^{th} percentile likelihood of the estimates used to adjust the exploration data. The likely value (302B) represents the data points corresponding to the 25^{th} to 75^{th} percentile likelihood of the estimates used to adjust the exploration data. Finally, upside value (302C) represents the data points corresponding to the 75^{th} to 100^{th} percentile likelihood of the estimates used to adjust the exploration data.

Following the generation of the probability distribution of FIG. 3, the downside risk adjustment module extracts the mean value of the distribution of the NAVs and the downside semi-deviation from the probability distribution. Assume that that the mean value of the distribution of the NAVs is $7.83, and the downside semi-deviation is $2.41. The following formula is used to determine the appropriate initial investment (ii) (exploration portfolio value), per share, of the exploration portfolio:

$$ii = \frac{Ep - SR \times dd}{Rf + 1}$$

As discussed above, the mean value of the distribution of NPVs (Ep) is $7.83, the Sharp ratio (SR) is 35%, the mean value minus the downside deviation (dd) ($7.83−$2.41) is $5.42, and the return required for cash flows not subject to exploration-specific risk (Rf) is $110%.

$$ii = \frac{\$7 .83 - ( .35 \times \$5 .42 )}{1.10 + 1}$$

The initial investment (ii) is therefore calculated as $2.83 per-share.

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for determining an exploration portfolio value comprising:
receiving a request for the exploration portfolio value targeting an exploration portfolio, wherein the request comprises exploration site data;
obtaining a fiscal regime estimation for the exploration site data;
obtaining a capital expenditure estimation for the exploration site data;
adjusting the exploration site data using the fiscal regime estimation and the capital expenditure estimation to obtain adjusted exploration site data;
generating a probability distribution by executing, using a computer processor, a Monte Carlo simulation on the adjusted exploration site data; and
determining the exploration portfolio value from the probability distribution.

2. The method of claim 1, wherein deriving the exploration portfolio value from the probability distribution comprises:
extracting a mean value of a distribution of a net asset value from the probability distribution;
extracting a downside semi-deviation from the probability distribution; and
determining the exploration portfolio value using the mean value of the distribution of the net asset value and the downside semi-deviation.

3. The method of claim 2, wherein determining the exploration portfolio value using the mean value of the distribution of the net asset value and the downside semi-deviation comprises applying the formula
$$ii = \frac{Ep - SR \times dd}{Rf + 1}$$
where ii is the exploration portfolio value, Ep is the mean value of the distribution of the net asset value, SR is a Sharp ratio, dd is the mean value minus the downside semi-deviation, and R is a required return.

4. The method of claim 1, wherein generating the probability distribution comprises executing the Monte Carlo simulation on the adjusted exploration site data iteratively using exploration site data adjusted according to different estimations of the fiscal regime and the capital expenditure for each iteration.

5. The method of claim 4, wherein the adjusted exploration site data is different for each iteration.

6. The method of claim 1, wherein the probability distribution comprises a plurality of data points exceeding 1000.

7. The method of claim 1, wherein the exploration portfolio comprises a reservoir extraction lease.

8. The method of claim 7, wherein the reservoir extraction lease comprises at least one from a group consisting of an oil well lease, a water well lease, a gas well lease, and a mine lease.

9. The method of claim 1, wherein adjusting the exploration site data using the fiscal regime estimation and the capital expenditure estimation to obtain the adjusted exploration site data comprises:
using a regression model to back out a relationship between field size discovered, depth of field discovered, and capital required per unit.

10. The method of claim 1, further comprising:
providing the exploration portfolio value to a sender of the request.

11. A non-transitory computer program product comprising computer readable program code embodied therein for performing a method, the method comprising:
receiving a request for the exploration portfolio value targeting an exploration portfolio, wherein the request comprises exploration site data;
obtaining a fiscal regime estimation for the exploration site data;
obtaining a capital expenditure estimation for the exploration site data;
adjusting the exploration site data using the fiscal regime estimation and the capital expenditure estimation to obtain adjusted exploration site data;
generating a probability distribution by executing, using a computer processor, a Monte Carlo simulation on the adjusted exploration site data; and
determining the exploration portfolio value from the probability distribution.

12. A system comprising:
a computer processor;
a fiscal regime abstraction module executing on the computer processor and configured to generate a fiscal regime estimation for exploration site data;
a capital expense abstraction module executing on the computer processor and configured to generate a capital expense estimation for the exploration site data;
a Monte Carlo simulation module executing on the computer processor and configured to:
receive a request for the exploration portfolio value targeting an exploration portfolio, wherein the request comprises the exploration site data,
obtain a fiscal regime estimation from the fiscal regime abstraction module,
obtain a capital expenditure estimation from the capital expense abstraction module,
adjust the exploration site data using the fiscal regime estimation and the capital expenditure estimation to obtain adjusted exploration site data, and
generate a probability distribution by executing, using a computer processor, a Monte Carlo simulation on the adjusted exploration site data; and
a downside risk adjustment module executing on the computer processor and configured to determine the exploration portfolio value from the probability distribution.

13. The system of claim 12, wherein the downside risk adjustment module is further configured to:
extract a mean value of a distribution of a net asset value from the probability distribution;
extract a downside semi-deviation from the probability distribution; and determine the exploration portfolio value using the mean value of the distribution of the net asset value and the downside semi-deviation.

14. The system of claim 13, wherein determining the exploration portfolio value using the mean value of the distribution of the net asset value and the downside semi-deviation comprises applying the formula
$$ii = \frac{Ep - SR \times dd}{Rf + 1}$$
where ii is the exploration portfolio value, Ep is the mean value of the distribution of the net asset value, SR is a Sharp ratio, dd is the mean value minus the downside semi-deviation, and R is a required return.

15. The system of claim 12, wherein generating the probability distribution comprises executing the Monte Carlo simulation on the adjusted exploration site data iteratively using exploration site data adjusted according to different estimations of the fiscal regime and the capital expenditure for each iteration.

16. The system of claim 15, wherein the adjusted exploration site data is different for each iteration.

17. The system of claim 12, wherein the probability distribution comprises a plurality of data points exceeding 1000.

18. The system of claim 12, wherein the exploration portfolio comprises a reservoir extraction lease.

19. The system of claim 18, wherein the reservoir extraction lease comprises at least one from a group consisting of an oil well lease, a water well lease, a gas well lease, and a mine lease.

20. The system of claim 12, wherein generating the capital expense estimation for the exploration site data comprises:
using a regression model to back out a relationship between field size discovered, depth of field discovered, and capital required per unit.
